(19) United States
(12) Patent Application Publication
(10) Pub. No.: US 2004/0137804 A1
(43) Pub. Date: Jul. 15, 2004

(54) Image pickup device having e-mail incoming indication means

(75) Inventor: Mei-Chi Chen, Taipei Hsien (TW)

Correspondence Address: BACON & THOMAS, PLLC, 625 SLATERS LANE, FOURTH FLOOR, ALEXANDRIA, VA, 22314

(73) Assignee: CHEN-SOURCE INC., Chung Ho City (TW)

(21) Appl. No.: 10/340,790

(22) Filed: Jan. 13, 2003

(51) Int. Cl. H01R 9/22

(52) U.S. Cl. 439/894

(57) ABSTRACT

An image pickup device using a lens to pick up images and a transmission interface to transmit picked up image signal to a computer is disclosed to have an indication signal output device adapted to receive a control signal from the mail server of the computer been connected when the mail server of the computer received an e-mail, and to produce an output signal indicative of the receipt of an e-mail by the mail server of the computer upon receipt of the control signal.

### BACKGROUND OF THE INVENTION

1. Field of the Invention

The present invention relates to an image pickup device and, more particularly, to such an image pickup device that provides an audio and/or visual indication signal when the computer to which the image pickup device connected receiving an e-mail.

2. Description of the Related Art

Following fast development of computer technology, a variety of advanced computer systems and computer peripheral apparatus such as network cards, modems, SCSI apparatus, disk drives, scanners, digital cameras, etc., are developed. An advanced computer system is generally equipped with a digital camera for picking up still image signal or motion image signal, for enabling picked up image signal to be transmitted to a remote computer or display means through the Internet. Further, people may use the Internet to receive and send e-mails. A computer can be set to output a visual indication signal through the display screen or an audio indication signal through the speaker when received an e-mail during the operation mode. However, under certain conditions (for example, under a power saving mode or when the computer running the audio/video system), the computer cannot give an indication signal to the user, informing the user of the incoming of an e-mail been duly received. In case the e-mail duly received carrying an important message, the user may be unable to answer the e-mail on time.

Therefore, it is desirable to provide a computer peripheral apparatus that gives a visual and/or audio indication signal when the computer received a new e-mail.

### SUMMARY OF THE INVENTION

The present invention has been accomplished under the circumstances in view. It is therefore the main object of the present invention to provide an image pickup device, which is connectable to a computer and, which has means to output a signal indicative of the incoming of an e-mail in the computer. According to one aspect of the present invention, the image pickup device comprises a shell and an image pickup circuit installed in the shell. The image pickup circuit comprises a lens adapted to pick up images, a transmission interface electrically connected to the lens and connectable to the transmission interface of a computer having a mail server and adapted to transmit image signal picked up by the lens to the computer been connected to the transmission interface of the image pickup circuit, and an indication signal output device electrically connected to the transmission interface of the image pickup circuit and adapted to receive a control signal from the mail server of the computer when the mail server of the computer received a new e-mail, and to produce an output signal indicative of the receipt of the e-mail. According to another aspect of the present invention, the indication signal output device can be a light emitting element, a speaker, or the combination of a light emitting element and a speaker.

### BRIEF DESCRIPTION OF THE DRAWINGS

FIG. 1 is an elevational view of the preferred embodiment of the present invention.

FIG. 2 is a sectional view of the preferred embodiment of the present invention.

FIG. 3 is a circuit block diagram, showing the image pickup circuit assembly electrically connected to a computer according to the present invention.

FIG. 4 is an operational flow chart of the present invention.

### DETAILED DESCRIPTION OF THE PREFERRED EMBODIMENT

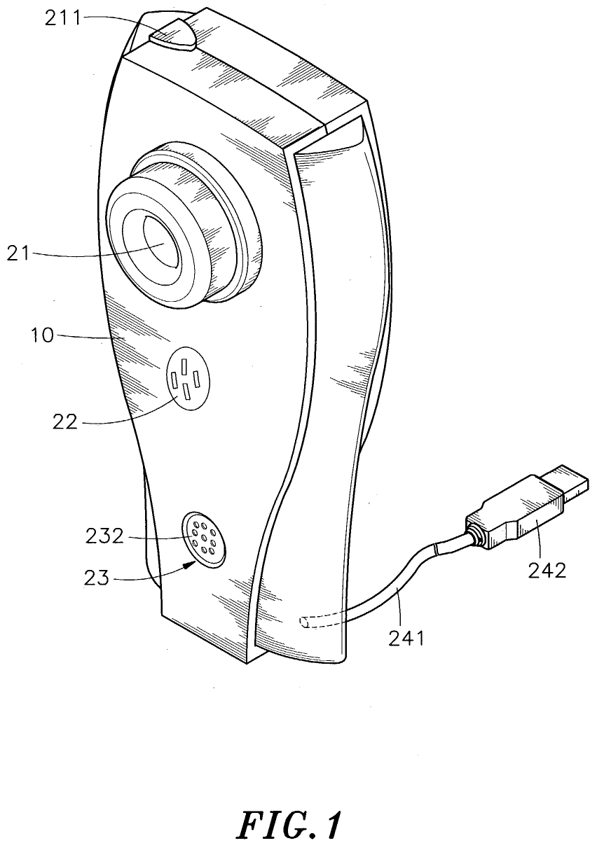

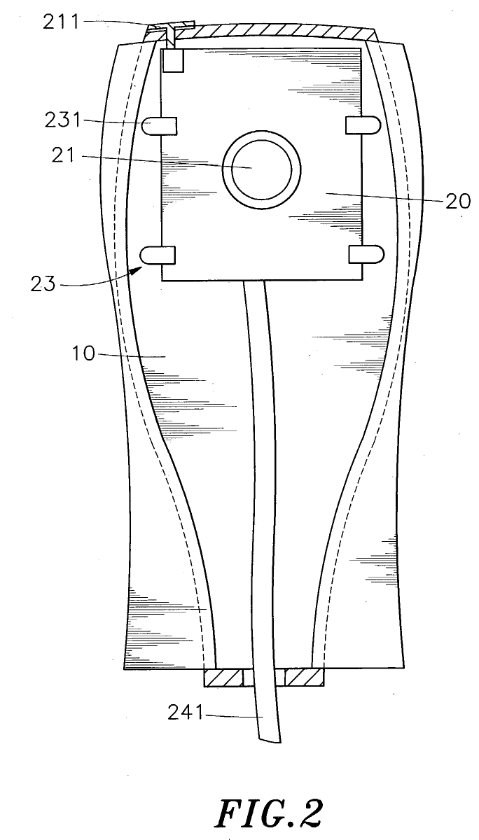

Referring to FIGS. 1-3 an image pickup device is shown comprising a shell 10 and an image pickup circuit 20 installed in the shell 10. The image pickup circuit 20 comprises a lens 21, a microphone 22, an indication signal output device 23, and a transmission interface 24. The transmission interface 24 comprises a signal line 241, and an electric connector 242 disposed at one end of the signal line 241 for electrically connecting the image pickup circuit 20 to the transmission interface 31 of a computer 30 having a speaker 32 for voice output and a mail server 33. When the lens 21 and microphone 22 continuously picking up dynamic video and audio signals or the lens 21 picking up a still image signal by means of the control of a shutter button 211 in the shell 10, the transmission interface 24 transmits the audio and video signals or the image signal to the computer 30. When the mail server 33 of the computer 30 received an incoming e-mail, the mail server 33 gives a control signal to the speaker 32 and the indication signal output device 23 via the transmission interface 24, thereby causing the speaker 32 to produce a sound indicative of the receipt of an e-mail, and the indication signal output device 23 to output an (audio/visual) indication signal indicative of the receipt of an e-mail. The indication signal output device 23 can be a light emitting element 231, a speaker 232, or the combination of a light emitting element 231 and a speaker 232.

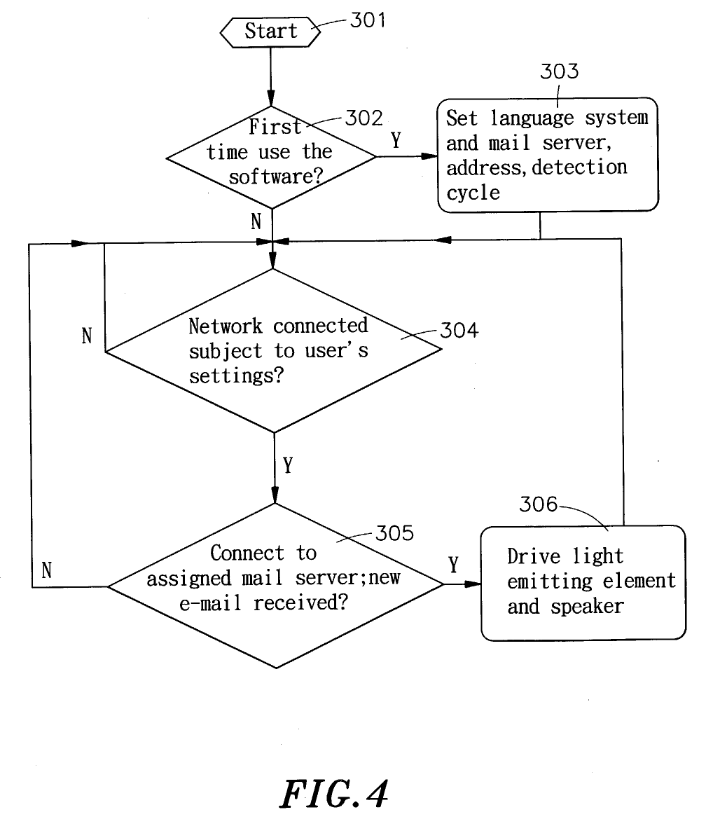

Referring to FIG. 4, when the image pickup circuit of the image pickup device electrically connected to the computer, it runs as follows:

(301) Start when electrically connected;

(302) Determine if it is the first time to use the software or not? Then, proceeds to step (303) if positive, or step (304) if negative;

(303) Set the language system, e-mail server, address and detection cycle, and then proceed to step (304) after setting;

(304) Determine if the set detection cycle exists or not, and if server address has been connected or not, and then proceed to step (305) if positive, or run step (304) again if negative;

(305) Determine if there is a new e-mail in the mail server of the computer assigned by the user or not, and then proceed to step (306) if positive, or return to step (304) if negative;

(306) Drive the audio and/or visual output device of the image pickup circuit to output an audio and/or visual signal indicative of the receipt of an e-mail, and then return to step (304).

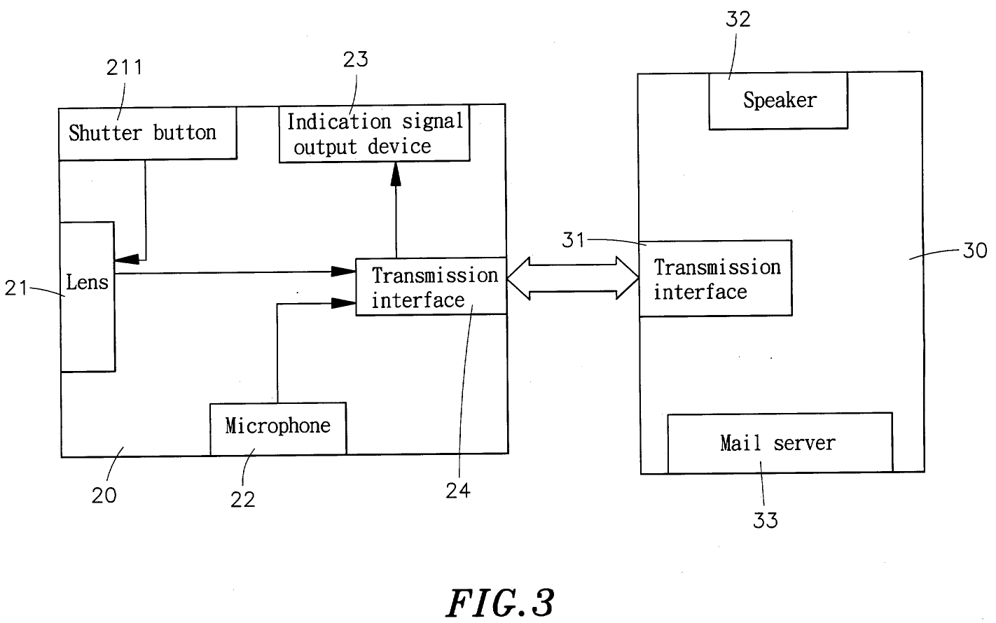

Referring to FIG. 3 again, the image pickup device can be a digital video camera or a digital. The lens 21 is requisite for picking up image signal. The shutter button 211 and the microphone 22 may be eliminated to simplify the structure.

According to the aforesaid embodiment, the transmission interface 24 is a cabled interface comprised of a signal line 241 and an electric connector 242. Alternatively, the transmission interface 24 can be a wireless signal transmission interface.

A prototype of image pickup device having e-mail incoming indication means has been constructed with the features of the annexed drawings of FIGS. 1-4. The image pickup device having e-mail incoming indication means functions smoothly to provide all of the features discussed earlier.

Although a particular embodiment of the invention had been described in detail for purposes of illustration, various modifications and enhancements may be made without departing from the spirit and scope of the invention. Accordingly, the invention is not to be limited except as by the appended claims.

What the invention claimed is:

1. An image pickup device comprising a shell and an image pickup circuit installed in said shell, said image pickup circuit comprising a lens adapted to pick up images, and a transmission interface electrically connected to said lens and connectable to the transmission interface of a computer having a mail server and adapted to transmit image signal picked up by said lens to the computer to which the transmission interface of said image pickup circuit is connected, wherein said image pickup circuit further comprises an indication signal output device electrically connected to the transmission interface thereof, and adapted to receive a control signal from the mail server of the computer been connected thereto when the mail server of the computer been connected thereto received an e-mail, and to produce an output signal indicating the receipt of an e-mail by the mail server of the computer been connected to said image pickup circuit upon receipt of said control circuit.

2. The image pickup device as claimed in claim 1, wherein said indication signal output device comprises a light emitting element adapted to produce a visual signal when received a control signal from the computer been connected to said image pickup circuit.

3. The image pickup device as claimed in claim 1, wherein said indication signal output device comprises a speaker adapted to produce an audio signal when received a control signal from the computer been connected to said image pickup circuit.

4. The image pickup device as claimed in claim 1, wherein said indication signal output device comprises a light emitting element and a speaker adapted to produce a visual signal and an audio signal respectively when received a control signal from the computer been connected to said image pickup circuit.

5. The image pickup device as claimed in claim 1, wherein said image pickup circuit further comprises a shutter button adapted to control closing and opening of said lens.

6. The image pickup device as claimed in claim 1, wherein said image pickup circuit further comprises a microphone electrically connected to the transmission interface thereof and adapted to pick up ambient voices.

7. An image pickup device comprising a shell and an image pickup circuit installed in said shell, said image pickup circuit comprising a lens adapted to pick up images, and a transmission interface electrically connected to said lens and connectable to the transmission interface of a computer having a mail server and adapted to transmit image signal picked up by said lens to the computer to which the transmission interface of said image pickup circuit is connected, for enabling the computer to output a control signal to drive a speaker thereof to sound when the mail server of the computer received an e-mail.
